(19) United States
(12) Patent Application Publication
(10) Pub. No.: US 2023/0353426 A1
(43) Pub. Date: Nov. 2, 2023

(54) Channel Estimation for an Antenna Array

(71) Applicant: Nokia Technologies Oy, Espoo (FI)

(72) Inventors: Yejian CHEN, Stuttgart (DE); Stefan WESEMANN, Kornwestheim (DE); Jafar MOHAMMADI, Stuttgart (DE); Thorsten WILD, Stuttgart (DE)

(21) Appl. No.: 17/923,138

(22) PCT Filed: May 10, 2021
(86) PCT No.: PCT/EP2021/062275

§ 371 Date: Nov. 3, 2022

(30) Foreign Application Priority Data
May 14, 2020 (FI) 20205487

(51) Int. Cl. H04L 25/02

(52) U.S. Cl. CPC H04L 25/0254; H04L 25/0212

(57) ABSTRACT

A method of channel estimation for an antenna array is disclosed. The method includes, receiving a signal transmitted by the antenna array, obtaining a neural network model trained for channel estimation using the received signal, inputting a representation of the received signal into the neural network model and generating a channel estimate for the received signal, and deciding whether to employ a further neural network model for the channel estimation.

### FIELD OF THE DISCLOSURE

The present disclosure relates to channel estimation for an antenna array.

### BACKGROUND OF THE DISCLOSURE

Accurate channel estimation, and thus precise Channel State Information (CSI), is a key technical prerequisite for advanced signal processing in both PHYsical (PHY) and Medium Access Control (MAC) layers. The objective of channel estimation is to extract the channel vector ‘H’ from a received signal vector ‘Y’ in order to accurately decode a transmitted signal ‘X’.

Conventional channel estimation methods for antenna array systems use a statistical system model designed to reach the underlying theoretical performance bounds. Such estimation methods typically rely on the second order channel statistics, i.e. the spatial covariance matrices. Machine learning based channel estimation solutions are known to provide a channel estimation performance approaching or even exceeding conventional channel estimation techniques, with a relatively lower computational complexity and without requiring explicit knowledge of the channel statistics.

Channel estimation for multi-antenna arrays, such as those used in multiple-input/multiple-output (MIMO) communication systems, can however still be problematic, because the computational complexity of any channel estimation method increases drastically with the number of antennas in the array. This computational complexity can make real-time processing of advanced estimation methods challenging.

### SUMMARY OF THE DISCLOSURE

A first aspect of the present disclosure provides a method of channel estimation for an antenna array, the method comprising, receiving a signal transmitted by the antenna array, obtaining a neural network model trained for channel estimation using the received signal, inputting a representation of the received signal into the neural network model and generating a channel estimate for the received signal, and deciding whether to employ a further neural network model for the channel estimation.

In other words, the method involves sampling a signal transmitted by the antenna array, for example, in the time domain as temporal symbols, or in the frequency domain as subcarriers. A neural network model trained for estimating channel for the received signal, i.e. a neural network model trained for channel estimation for a signal with the same spatial characteristics, as the received signal, is then obtained, and a sample of the received signal is input into the neural network model to thereby predict a channel estimate for the received signal. The channel estimate may then be transmitted to a signal decoder of a receiving device receiving the transmitted signal, to allow accurate decoding of the transmitted signal.

In a final step, the method involves deciding whether to employ a further, successive, neural network model for the channel estimation task. Employing a further trained neural network model, in succession with the neural network model, and having as an input the channel estimate output of the neural network model, may advantageously improve the accuracy of the channel estimation task. However, a further neural network model may only be employed where computational resource permits execution of the further neural network model.

The disclosed method thus facilitates an iterative approach to channel estimation, whereby successive neural network models have as an input the channel estimate of the preceding neural network model. The accuracy of the channel estimate output by each successive neural network model may be expected to increase progressively.

This iterative approach, and in particular, the step of deciding whether to employ further neural network models for the channel estimation task, allows for the computational complexity of the method to be readily adapted to suit the computational resource of the device executing the method. For example, it may be generally desirable for the channel estimate to be as accurate as possible. However, this desire for accuracy of the channel estimate must be balanced against the available computational resource for running each neural network model. This balance is particularly important where computational resource is shared between multiple user equipment

Because each iteration of the method produces a channel estimate (subject to a level of error), after any iteration the inference process may be terminated and the channel estimation read. Alternatively, if improved accuracy of the channel estimate is required, and if sufficient computational resource is available, further iterations of the method may be performed to improve the accuracy of the channel estimation. The disclosed method thus allows for the computational complexity of the channel estimation task to be readily adapted to suit a wide range of hardware platforms with differing computational capabilities.

In an embodiment, the method comprises deciding to employ a further neural network for the channel estimation, obtaining a further neural network model trained for channel estimation using the channel estimate generated by the neural network model, and inputting the channel estimate into the further neural network model to generate a further channel estimate for the received signal.

In other words, the method may comprise, in response to a decision that a further, successive, neural network model should be deployed for the channel estimation task, obtaining a further neural network model, the further neural network model being trained for channel estimation using a channel estimate generated by the initial neural network model, inputting the channel estimate of the initial neural network model into the further neural network model, and outputting a further channel estimate using the further neural network model. Thus, the further channel estimate generated by this second iteration of the channel estimation task may advantageously be expected to be more accurate than the channel estimate generated by the first iteration.

In an embodiment, deciding whether to employ a further neural network model for the channel estimation comprises determining a computational capacity for performing operations of a further neural network model.

In other words, the method may comprise assessing whether sufficient computational resource is available on the computing device being used to execute computations of the method. This may advantageously ensure that a further neural network model is only executed if sufficient computational resource is available. This determination may be particularly important where the computing device is being used to execute channel estimation tasks for multiple user equipment, as this may allow available computational resource to be appropriately divided between the multiple user equipment to obtain the multiple channel estimations to an appropriate degree of accuracy.

In an embodiment, obtaining the neural network model comprises training a neural network model for channel estimation using labelled input data, storing parameters of the trained neural network model in memory, and retrieving the stored parameters from the memory. In other words, the method may further comprise an initial task of training a neural network model for the channel estimation tasks using the labelled training data as an input. This training step thus relates to training an initial neural network model relevant to a first iteration of the channel estimation task. This training could be performed ‘on-line’, i.e. on the computing device executing the channel estimation tasks, or could alternatively be performed ‘offline’, i.e. using a different computing device.

In an embodiment, obtaining the further neural network model comprises training a further neural network model using a channel estimation of the neural network model and a label of the input data, storing parameters of the trained further neural network in memory, and retrieving the stored parameters from the memory. In other words, the method may involve training a further neural network model for a channel estimation task based on an input that is the channel estimate output generated by the initial neural network model. Similarly, this training task could be performed ‘on-line’ or ‘off-line’

In an embodiment, inputting a representation of the received signal into the neural network model comprises inputting a spatial covariance matrix representation of the received signal.

In an embodiment, obtaining the neural network model comprises training a neural network model for channel estimation using labelled input data corresponding to a plurality of spatially different spatial positions and/or a range of differing SNR values, storing parameters of the trained neural network model in memory, and retrieving the stored parameters from the memory.

In other words, the method may comprise training the neural network model so as to be capable of estimating channel in communications between a transmitter, e.g. a base station, and a receiver, e.g. a mobile handset, for a plurality of different spatial positions of the receiver. Consequently, because the neural network model is suitable for channel estimation for a plurality of different positions of the receiver, the accuracy with which the spatial position of the receiver needs to be estimated when selecting a neural network model for use during an inference stage is reduced.

Furthermore, because the neural network model spans a range of different spatial positions, fewer neural network models are required to be trained and stored for channel estimation across the range. As a result, the time required for training neural network models, and the storage capacity required for storing the neural network models, may be reduced.

In an embodiment, the method is deployed for channel estimation for a two-dimensional antenna array, and the method comprises receiving a signal transmitted by a first spatial dimension of the antenna array and by a second spatial dimension of the antenna array, obtaining a first neural network model trained for channel estimation for the first spatial dimension of the antenna array, and a second neural network model trained for channel estimation for the second spatial dimension of the array, inputting a representation of the received signal for the first spatial dimension of the antenna array into the first neural network model and generating a channel estimate for the first spatial dimension of the array, and inputting a representation of the received signal for the second spatial dimension of the antenna array into a second neural network model and generating a channel estimate for the second spatial dimension of the antenna array, and combining the channel estimates for the first spatial dimension of the antenna array and for the second spatial dimension of the antenna array to generate a channel estimate for the antenna array.

In other words, the method may involve decomposing the channel estimation task into separate, independent, tasks of estimating channel for discrete dimensions of a two-dimensional array. By treating each antenna array dimension independently, as different Uniformly Linear Array (ULA) antennas, the spatial covariance matrix of a two-dimensional array can be decomposed as the Kronecker-product of a covariance matrix for the first spatial dimension, e.g. a vertical dimension, and a covariance matrix for the second spatial dimensions, e.g. a vertical dimension, of the two-dimensional antenna array. The training for a full spatial covariance matrix of a two-dimensional array, denoted as highly complex brute-force training, can thus be replaced by low complexity subspace training with multiple parallelized neural networks each estimating for a particular spatial dimension, e.g. for the horizontal and vertical dimension. This may thus achieve a complexity cost saving factor. The multiple subspace channel estimates, in this case the channel estimates for the first and second spatial dimensions, e.g. vertical and horizontal spatial dimensions, may then be combined e.g. simply-averaged, to obtain channel estimates. Furthermore, as a consequence of treating array dimensions independently, multiple channel estimates are obtained for antenna elements of the array, e.g. a channel estimate for the first spatial dimension and a channel estimate for the second spatial dimension. This multi-dimensional combining gain may be expected to advantageously improve the accuracy of the channel estimation for the received signal.

In an embodiment, combining the channel estimates for the first spatial dimension of the antenna array and for the second spatial dimension of the antenna array comprises computing an arithmetic mean or a geometric mean of the channel estimates. The arithmetic mean may advantageously represent a relatively low complexity solution for combing the channel estimates.

In an embodiment, the first and second spatial dimensions are horizontal and vertical dimensions respectively of the two-dimensional antenna array.

In an embodiment, obtaining a first neural network model trained for channel estimation for the first spatial dimension of the antenna array, and a second neural network model trained for channel estimation for the second spatial dimension of the array, comprises training first and second neural network models respectively for channel estimation using labelled training data.

In an embodiment, obtaining a first neural network model trained for channel estimation for the first spatial dimension of the antenna array, and a second neural network model trained for channel estimation for the second spatial dimension of the array, comprises training first and second neural network models respectively for channel estimation using labelled training data corresponding to a plurality of spatially different spatial positions and/or a range of differing SNR values.

In an embodiment, the method further comprises receiving a signal transmitted by a third spatial dimension of the antenna array and by a fourth spatial dimension of the antenna array, obtaining a third neural network model trained for channel estimation for the third spatial dimension of the antenna array, and a fourth neural network model trained for channel estimation for the fourth spatial dimension of the array, inputting a representation of the received signal for the third spatial dimension of the antenna array into the third neural network model and generating a channel estimate for the third spatial dimension of the array, and inputting a representation of the received signal for the fourth spatial dimension of the antenna array into the fourth neural network model and generating a channel estimate for the fourth spatial dimension of the antenna array, and combining the channel estimates for each of the first to the fourth spatial dimensions of the antenna array to generate a channel estimate for the antenna array.

In other words, the method may further comprise obtaining channel estimates for further spatial dimensions of the array. For example, the first and second spatial dimensions may be vertical and horizontal spatial dimensions, and the third and fourth spatial dimensions may be mutually different diagonal dimensions of the two-dimensional antenna array. Obtaining additional channel estimates addresses the problem that the decomposition of the full-dimensional (spatial) channel covariance matrix into the Kronecker-product of only two spatial covariance matrices, e.g. horizontal and vertical (spatial) covariance matrices, is only an approximation. The spatial correlation information that is lost by this approximation may advantageously be included in the channel estimation procedure by considering the further spatial dimensions, e.g. the diagonal array dimensions.

A second aspect of the present disclosure provides a computer program comprising instructions, which, when executed by a computer, cause the computer to carry out the method of any one of the preceding statements.

A third aspect of the present disclosure provides a computer-readable data carrier having the computer program of the second aspect of the disclosure stored thereon.

A fourth aspect of the present disclosure provides a computer configured to perform a method of any one of the preceding statements.

A fifth aspect of the present disclosure provides an antenna array configured to operate in accordance with a method of any one of the preceding statements.

A sixth aspect of the present disclosure provides a base station for a wireless communication network, the base station comprising an antenna array according to the fifth aspect of the present disclosure for wirelessly communicating with remote user equipment.

A seventh aspect of the present disclosure provides a wireless communication network comprising a base station according to the sixth aspect of the present disclosure and remote user equipment in wireless communication with the base station via the antenna array.

These and other aspects of the invention will be apparent from the embodiment(s) described below.

### BRIEF DESCRIPTION OF THE DRAWINGS

In order that the present invention may be more readily understood, embodiments of the invention will now be described, by way of example, with reference to the accompanying drawings, in which:

FIG. 1 shows schematically an example of a wireless communication network embodying an aspect of the invention;

FIG. 2 shows schematically a computer configured for channel estimation in the wireless communication network previously identified with reference to FIG. 1;

FIG. 3 shows processes of a method of channel estimation run on the computer identified with reference to FIG. 1, which includes a process of training neural network models for channel estimation tasks, and a process of using the trained neural network models for channel estimation tasks;

FIGS. 4 and 5 show schematically processes involved in training neural network models for channel estimation tasks, which includes a process of combining estimates for channel of vertical and horizontal subspaces of the channel;

FIG. 6 shows a visualisation of a signal model for a two-dimensional antenna array;

FIG. 7 shows a visualisation of a process of stacking vertical slices of the signal model previously identified with reference to FIG. 6 in a horizontal spatial domain and stacking horizontal slices of the signal model in a vertical spatial domain;

FIG. 8 shows schematically processes involved in combining estimates for channel of subspaces of the channel;

FIG. 9 shows schematically processes involved in training the neural network models for channel estimation tasks;

FIGS. 10 and 11 show schematically processes involved in using the trained neural network models for channel estimation tasks;

FIG. 12 shows a visualisation of a modification to the method of channel estimation, in which additional diagonal subspaces of the channel are considered in the channel estimation task;

FIG. 13 shows a visualisation of a method of training neural network models for use in estimating channel across a plurality of different spatial positions;

FIG. 14 shows a method of selecting a neural network model for inference during a channel estimation stage in dependence on a position of a receiver of the wireless communication network relative to a transmitter of the wireless communication network; and

FIG. 15 shows a visualisation of a treatment of a signal model for the wireless communication network, in which the signal is considered in four dimensions.

### DETAILED DESCRIPTION OF THE DISCLOSURE

A wireless communication network 101 embodying an aspect of an invention of the present disclosure is illustrated schematically in the Figures.

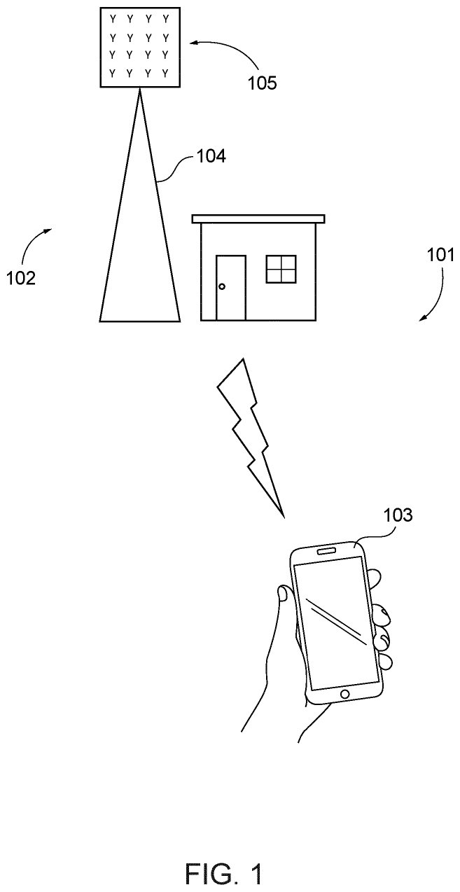

Referring firstly to FIG. 1, the wireless communication network 101 comprises a base station, indicated generally at 102, in wireless communication with plural remote user equipment, such as user equipment 103. Base station 102 comprises a mast 104 supporting a two-dimensional antenna array 105 at a height above ground level. Remote user equipment 103 comprises a hand-held cellular telephone handset. Handset 103 comprises one or more internal antenna, each of the one or more antenna comprising a radiator and a radio chain pair. The base station 102 and telephone handset 103 are configured to communicate via radio-frequency transmission, for example, via radio communication operating according to the Long-Term Evolution (LTE) telecommunications standard.

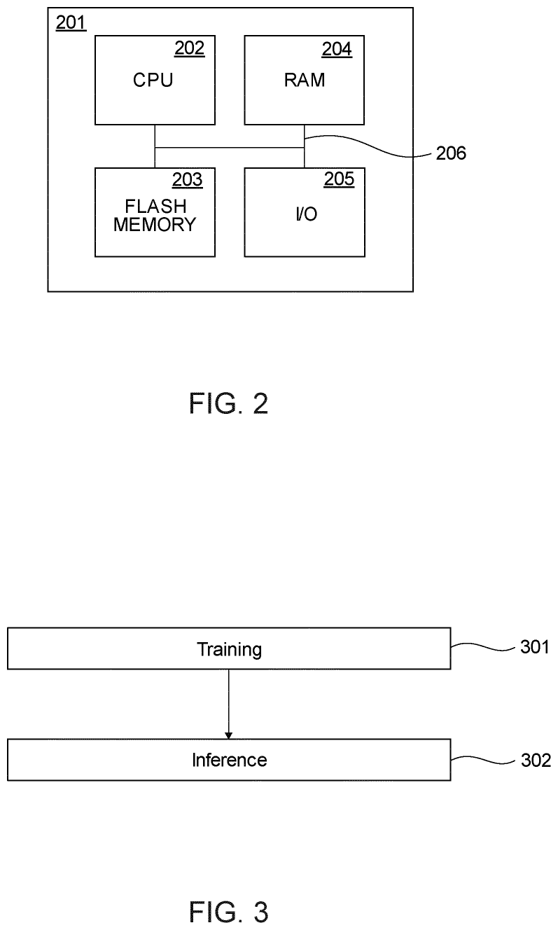

Referring next to FIG. 2, base station 102 comprises a computing device, in the form of computer 201, configured to estimate channel in signals transmitted between the two-dimensional antenna array 105 of the base station 102 and the internal antennas of the handset 103.

Computer 201 embodying an aspect of the invention comprises central processing unit 202, flash memory 203, random-access memory 204, input/output interface 205, and system bus 206. The computer 201 is configured to run neural network models for estimation of channel in communications between the base station 102 and the handset 103.

Central processing unit 202 is configured for execution of instructions of a computer program. Flash memory 203 is configured for non-volatile storage of computer programs for execution by the central processing unit 202. Random-access memory 204 is configured as read/write memory for storage of operational data associated with computer programs executed by the central processing unit 202. Input/output interface 205 is provided for connection of external computing devices and/or other peripheral hardware to computer 201, to facilitate control of the computer 201 and inputting of input data. The components 202 to 205 of the computer 201 are in communication via system bus 206.

In the embodiment, the flash memory 203 has a computer program for channel estimation using neural network models stored thereon. The computer 201 is thus configured, in accordance with the instructions of the computer program, to train neural network models for estimating channel in signals transmitted between the antenna array 205 of the base station 202 and the plural user equipment in communication with the base station 202, such as handset 103, sample signals received by the user equipment, such as handset 103, from the base station 202, and process the sampled signal on the central processing unit 202 using the trained neural network models to thereby generate one or more channel estimates predictions for the received signal. The computer 201 is then configured to transmit the channel estimations to a signal decoder of the handset 103 in order to allow correct recovery of the transmitted signal ‘X’ from the received signal ‘Y’ by compensating for the channel ‘H’.

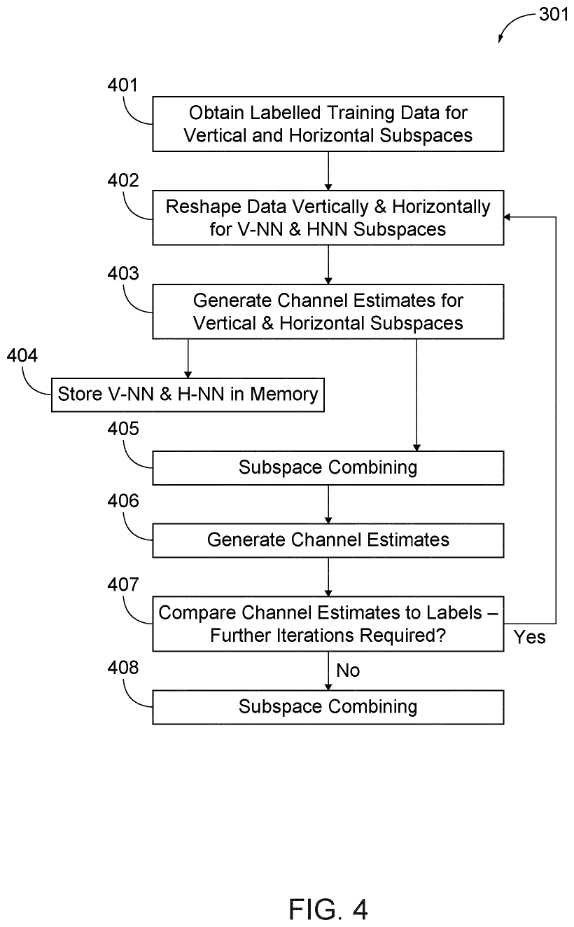

Referring in particular to FIG. 3, the computer program for channel estimation stored on the flash memory 103 of computer 101 comprises two stages.

At stage 301, the computer program causes the central processing unit 202 to train neural network models for channel estimation, and store the trained neural network models in the flash memory 203.

At stage 302, the computer program causes the central processing unit 202 to generate channel estimations for a signal transmitted by the base station 102 and received by the handset 103 using the neural network models trained at stage 301.

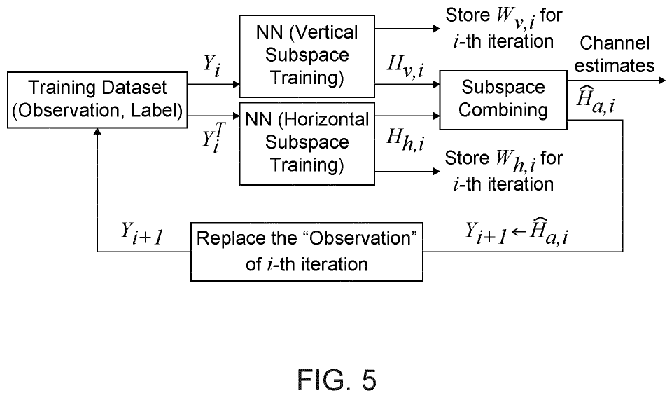

Referring in particular to FIGS. 4 and 5, the method of stage 301 for training neural network models for channel estimation comprises eight stages.

At stage 401, labelled training data is obtained for channel estimation of signals transmitted by the base station 102 to the handset 103.

At stage 401, the labelled training data is reshaped vertically and horizontally for vertical and horizontal spatial dimensions respectively of the antenna array 105 of the base station 102.

At stage 402, the labelled training data is input into parallelised first and second neural network models.

A stage 403, the first and second neural network models are executed on the input to thereby generate channel estimates Hᵥ, Hₕ for vertical and horizontal spatial dimensions respectively of the antenna array 105.

At stage 404, parameters, such as weights, of the first and second neural network models respectively are stored in flash memory 203 of the computer 201.

At stage 405, the channel estimates Hᵥ, Hₕ are combined to obtain at stage 406 a channel estimate H for the signal received by the handset 103.

At stage 407, the channel estimates H are compared to the corresponding label of the input labelled training data, to determine a magnitude of an error in the channel estimates H compared to the label. A determination is then made as to whether the accuracy of the channel estimates H satisfy a threshold accuracy value. For example, the threshold accuracy value could be a value manually input by a user of the system denoting a desired accuracy of channel estimates obtained during the inference stage 302. If the determination a stage 407 is answered in the negative, indicating that the channel estimates H are sufficiently accurate, the method proceeds to termination at stage 408.

In the alternative, if the determination at stage 407 is answered in the affirmative, indicating that channel estimates of the first and second neural network models are insufficiently accurate, the weights of the first and second neural network models are updated, and the channel estimates H obtained by stage 406 are output and substituted in place of the corresponding observations of the labelled training data input at stage 402. The method of stages 402 to 407 is then repeated, using the updated weights for the first and second neural network models, by inputting the channel estimates H into the updated first and second neural network models.

Stages 402 to 407 may then be performed repeatedly, i.e. iteratively, until the determination at stage 407 is finally answered in the negative, at which time the training phase is ended at stage 408.

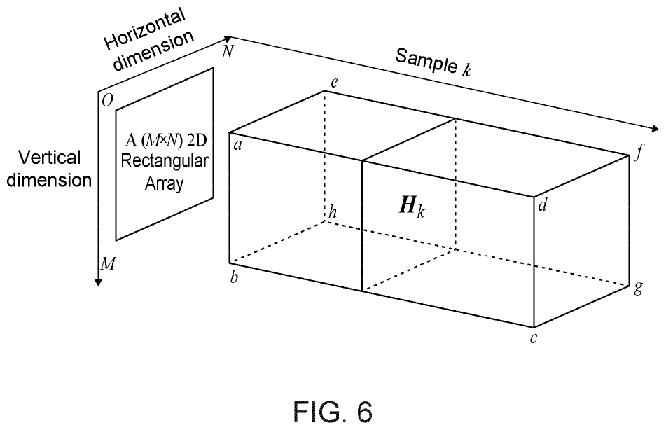

Referring in particular to FIGS. 6 to 8, the method of stage 405 for combining the channel estimates Hᵥ, Hₕ for the vertical and horizontal spatial dimensions respectively of the antenna array of the base station may comprise computing an arithmetic or geometric mean of the subspace channel estimates.

In the embodiment, the Kronecker covariance model is employed to perform training of the neural networks for the vertical and horizontal spatial dimensions respectively. With the Kronecker model, the spatial covariance matrix of a two-dimensional antenna array may be approximated as the Kronecker product of a vertical covariance matrix and a horizontal covariance matrix. The training for the full spatial covariance matrix of a two-dimensional array, denoted as highly complex brute-force training, can thus be replaced by low complexity subspace training with two neural networks in horizontal and vertical spatial domains by separating the three-dimensional channel into azimuth and elevation dimensions and treating the dimensions as independent two-dimensional channels. This thus achieves a complexity cost saving factor. The two subspace channel estimates may then be combined e.g. simply-averaged, to obtain channel estimates. Furthermore, as a consequence of treating array dimensions independently, we obtain for each antenna element two estimates, one from the horizontal estimator and one from the vertical estimator. This additional horizontal/vertical combining gain can be expected to improve the accuracy of the channel estimation.

Thus, referring in particular to FIG. 6, it is to be understood that a M×N rectangular antenna array may be represented as M-fold 1×N horizontal, or equivalently as N-fold M×1 vertical arrays. Because all of the horizontal and vertical arrays are understood to follow the statistics given by N×N horizontal covariance matrix Rₕ and M×M vertical covariance matrix Rᵥ respectively, the channel estimation task may be executed independently in horizontal and vertical directions, I.e. horizontal and vertical subspaces, using two neural network models. As a consequence, two channel estimates, one from the horizontal dimension estimator neural network model and one from the vertical dimension estimator neural network model, may be obtained. Thus, referring to FIG. 6, a first neural network model may be trained based on the vertical dimension, denoted by plane ‘abcd’, and the second neural network model may be trained based on the horizontal dimension, denoted by the plane ‘adfe’. It can be found that the channel along the line ‘ad’ is the overlapped part of the two independent subspaces, which is without the loss of generality. This additional horizontal/vertical combining gain may be expected to further improve the accuracy of the channel estimation task.

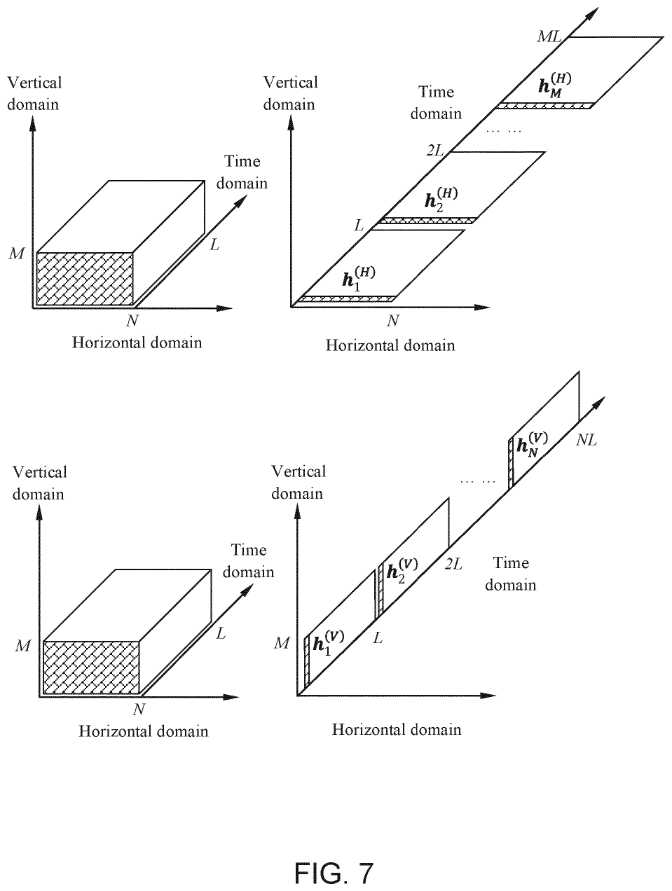

Thus, referring next in particular to FIG. 7, the channel estimation task may be considered in terms of horizontal and vertical spatial domains, i.e. subspaces. The data slices may be stacked horizontally and vertically to create two independent signal observations, the N×M horizontal matrix Hₕ and the M×N vertical matrix Hᵥ, which matrices may be defined by Equations 1 and 2 respectively.

Hₕ=[h₁^{(h)} . . . h_{M}^{(h)}] Equation 1:

Hᵥ=[h₁^{(v)} . . . h_{N}^{(v)}], Equation 2:

Considering MMSE channel estimation for both spatial dimensions, i.e. subspaces individually, matrices Hₕ and Hᵥ may thus be given by equations 3 and 4 respectively, where Wₕ and Wᵥ denote N×N and M×M MMSE weighting matrices, and the channel observation is denoted as M×N matrix Y.

Hₕ=WₕY^{T}=Rₕ(Rₕ+σ²I_{N})⁻¹Y^{T} Equation 3:

Hᵥ=WᵥY=Rᵥ(Rᵥ+σ²I_{M})⁻¹Y Equation 4:

Thus, the arithmetic mean of the independent channel estimates of the vertical and horizontal spatial dimensions may be given by equation 5.

Ĥₐ=0.5(Hₕ^{T}+Hᵥ)=0.5(WᵥY+YWₕ^{T}). Equation 5:

Equation 5 may be reformulated as the vectorized expression of equation 6, where the MN×MN matrix of equation 7 is the effective weighting with respect to an arithmetic mean of the subspace channel estimates.

vec(Ĥₐ)=0.5(I_{N}⊗Wᵥ+Wₕ⊗I_{M})vec(Y),Equation 6:

Wₐ=0.5(I_{N}⊗Wᵥ+Wₕ⊗I_{M} Equation 7:

It is alternatively possible to consider the geometric mean of the subspace channel estimates, which may be given by equation 8, where the MN×MN matrix W_{g} given by equation 9 is the effective weighting with the geometric mean.

vec(Ĥ_{g})=(I_{N}⊗Wᵥ)^{0.5}(Wₕ⊗I_{M})^{0.5}vec(Y)=Wₕ^{0.5}⊗Wᵥ^{0.5})vec(Y), Equation 8:

W_{g}=Wₕ^{0.5}⊗Wᵥ^{0.5} Equation 9:

Thus, the geometric mean of the independent channel estimates of the vertical and horizontal spatial dimensions may be given by equation 10.

Ĥ_{g}=Wᵥ^{0.5}Y(Wₕ^{0.5})^{T}. Equation 10:

The equations indicate that the geometric mean [symbol] can provide the channel estimates to a greater accuracy. However, in computing the geometric mean [symbol] , the matrix square root operation (⋅)0.5 has to be invoked for matrices Wᵥ and Wₕ, which introduces additional complexity due to the non-linear operation.

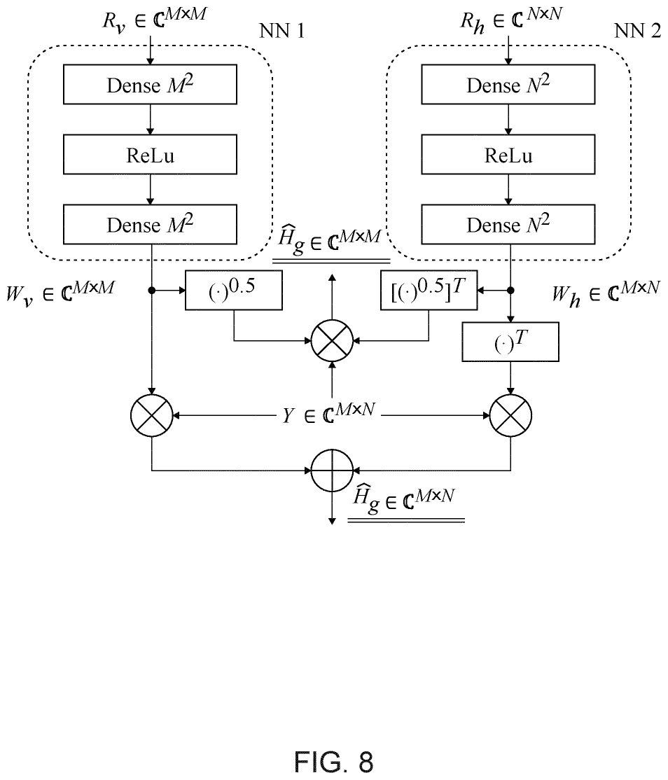

Referring next in particular to FIG. 8, in view of the foregoing analysis, it can be asserted that the Kronecker-product enables natural exploitation of the spatial decomposition, thereby allowing treating of the horizontal and vertical spatial dimensions individually as Uniform Linear Array (ULA) antennas. First and second neural network models may thus be executed in parallel, each of which has a simple two-layer structure with ReLu activation. The same M×N×K data structure of FIG. 7 may then be reconstructed and input to each of the neural network models as the observations for vertical and horizontal subspaces. The inputs and outputs of the neural networks are spatial sample covariance matrixes Rᵥ, Rₕ, and the weight matrices Wᵥ, Wₕ respectively.

In the example of FIG. 8, two parallel neural networks are depicted, each of which has two concatenated dense, i.e. fully-connected, layers. The number of real values as the input parameters of the network is 2(M²+N²). The number of the stored real values of both NNs is 4(M⁴+N⁴). The total computational cost of subspace training, to involve parameter passing, ReLu operation, real/imaginary part matrix multiplication, and finally subspace combining is O(16MN⁴+16NM⁴+5MN²+5NM²−2MN).

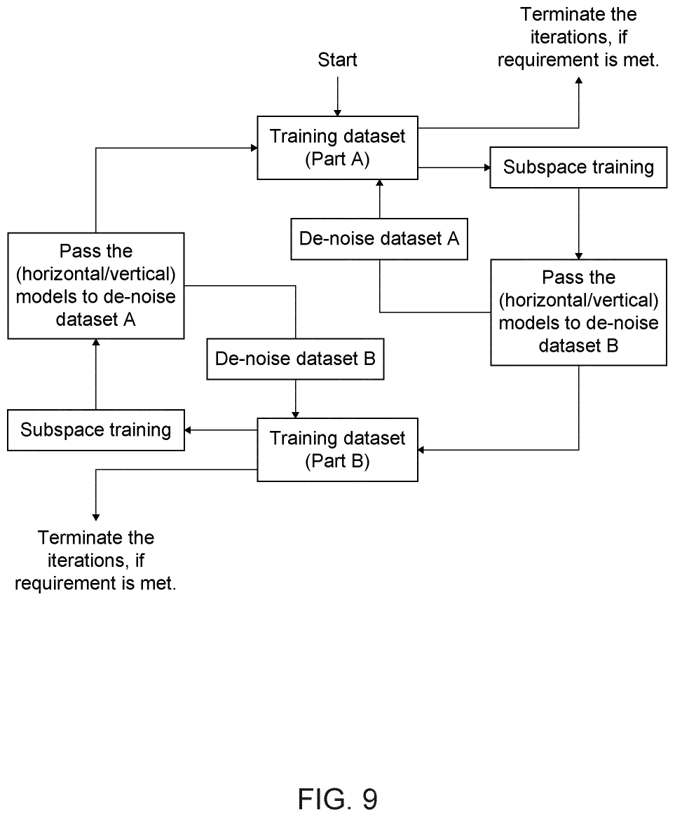

Referring next to FIG. 9, the method of stage 301 for training the neural networks for the channel estimation task may involve dividing the total labelled training data set into two parts, part A and part B.

The subspace training may then be carried out for training dataset A. The neural network models of horizontal and vertical subspaces may be passed to training dataset B for de-noising. Subsequently a new subspace training may be started with the de-noised training dataset B. Similarly, the neural network models of subspaces will be passed to training dataset A. This constitutes one iteration. The training weights are delivered from one iteration to the next iteration. This introduces independent subspace diversity to increase the effective SNR for the training in the next iteration.

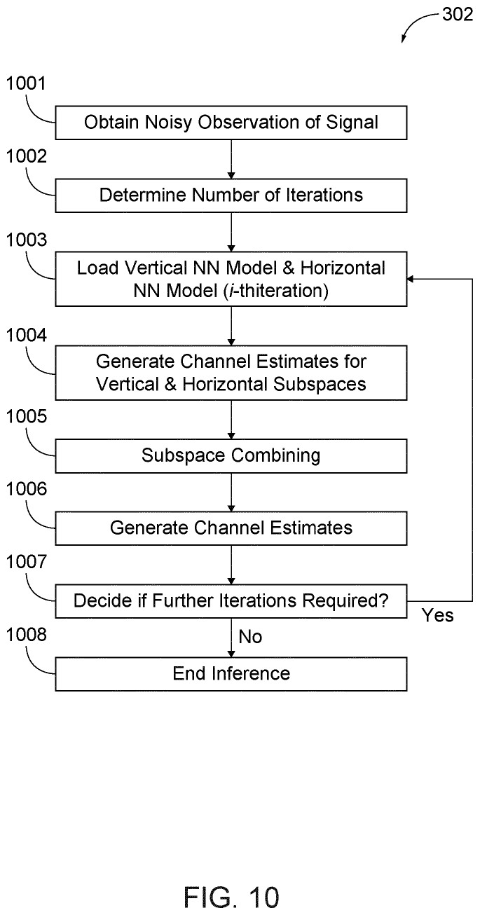

Referring next to FIGS. 10 and 11, the method of stage 302 for using the trained neural network models for channel estimation comprises eight stages.

At stage 1001, observations are made of a signal transmitted by the antenna array 105 of the base station 102.

At stage 1002, a determination of a number of channel estimation iterations to be performed is made. In an example, the determination at stage 1102 takes account of an available computational capacity of CPU 202 of computer 201 for performing computational operations. If the network is under high load, e.g. when a large number of user equipment is served, and thus many instances of channel estimation are required, equation 11 holds.

n_{UE}×nᵢₜₑᵣₐₜᵢₒₙ=C_{SoC} Equation 11:

Where, n_{UE} is the number of active UEs, nᵢₜₑᵣₐₜᵢₒₙ is the number of iterations to be performed, and C_{SoC} is the computational capacity of the CPU 202 available for channel estimation tasks. From equation 11, the algorithm adaptively adjusts the number of channel estimation iterations to the load of the network. This requirement could be stated as an input that lets the algorithm limit the number of iterations according to Equation 11:

nᵢₜₑᵣₐₜᵢₒₙ=C_{SoC}/n_{UE}. Equation 11:

After being combined in horizontal and vertical subspaces, the channel estimates still exhibit residual additive noise, which is Gaussian but with reduced variance, compared to the noise in the channel observation input. The key idea of the inference method depicted schematically in FIG. 10 is to apply the neural network based channel estimator processed repeatedly to the produced channel estimates, whilst using in each run, i.e. each iteration, a dedicated set of weights, i.e. a dedicated neural network model per iteration. This iterative procedure allows processing gain which iteratively improves the accuracy of the channel estimate. However, because each iteration results in generating of a channel estimate, subject to a progressively reducing error, the procedure may be terminated after completion of an iteration, and the channel estimate read. Alternatively, if further computational processing resource is available, the channel estimate of an iteration may be input into a further iteration to further improve the accuracy of the channel estimation. Accordingly, the method allows for scalable processing complexity and adaptation of the processing complexity in realtime to adapt to computational demand.

The determination at stage 1002 may thus allow for ready adaptation of the complexity/accuracy of the method in dependence on an available computational capacity for performing computational operations of the iterations.

At stage 1003, the vertical neural network and horizontal network models for the i-th iteration, as generated during the training phase 301, are loaded.

At stage 1004, the noisy observation of the received signal is input into the first and second neural networks, and channel estimates for the vertical and horizontal spatial dimensions respectively are obtained.

At stage 1005, the channel estimates for the vertical and horizontal spatial dimensions obtained at stage 1004 are combined, for example, by computing an arithmetic mean value using Equation 5, to thereby generate a channel estimate [symbol] at stage 1006.

At stage 1007, a determination is made as to whether further iterations of stages 1003 to 1006 are required, by reference to the determination of the required number of iteration obtained at stage 1002. If the determination is answered in the negative indicating that further iterations are not required, the method proceeds to termination at stage 1008.

In the alternative, if the determination at stage 1007 is determined in the affirmative, indicating that further iterations are required, the weights of the neural networks models are updated to weights corresponding to a second iteration as learned at stage 301, and channel estimate [symbol] is input into the updated neural networks, and stages 1003 to 1007 are repeated until the determination at stage 1007 is answered in the negative, indicating that all iterations prescribed by the determination at stage 1002 have been performed, and the channel estimate may then be output to a signal decoder of the handset 103.

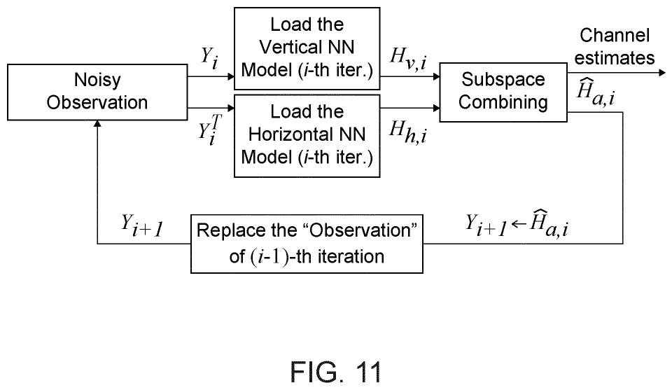

Referring finally to FIG. 12, in a modification to the method described previously with reference to FIGS. 1 to 11, in addition to horizontal and vertical spatial dimensions, i.e. subspaces, additional diagonal spatial dimensions may be employed both for training stage 301 and inference stage 302.

Thus, in the modification to the method, in addition to training of horizontal and vertical neural networks, two additional diagonal spatial dimension neural networks may be similarly trained at stage 301, and deployed at inference stage 302 in parallel with the first and second neural networks. As indicated in the Figure, in the example the (8-2)-th antenna element will thus be processed in vertical subspace by the first neural network, horizontal subspace by the second neural network, and mutually different diagonal subspaces by the third and fourth neural networks. The use of the two additional neural networks for the diagonal dimensions is motivated by the recognition that the decomposition of the full-dimensional (spatial) channel covariance matrix into the Kronecker-product of horizontal and vertical spatial covariance matrices is only an approximation. The spatial correlation information that is lost by this approximation may be included in the channel estimation procedure using the diagonal array dimensions.

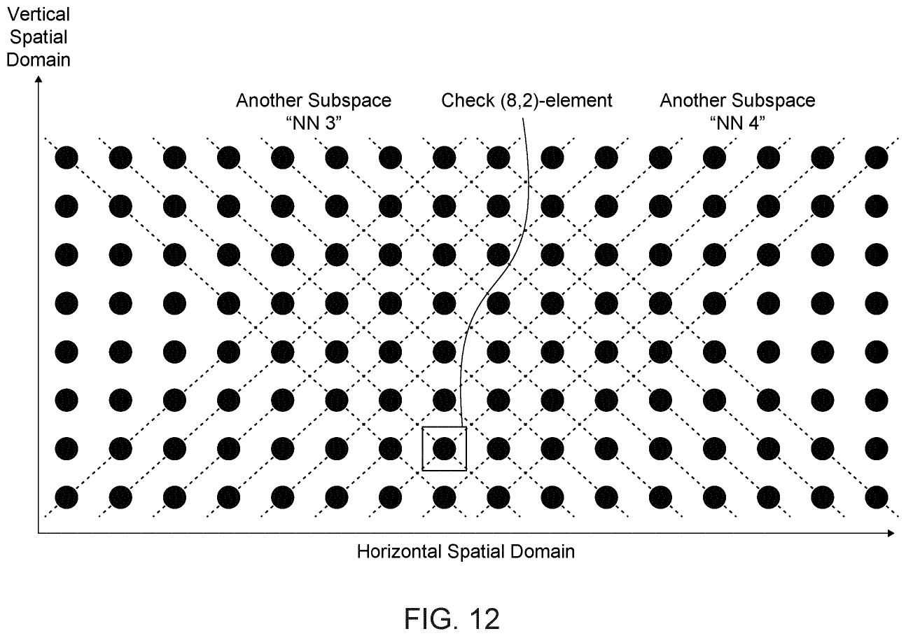

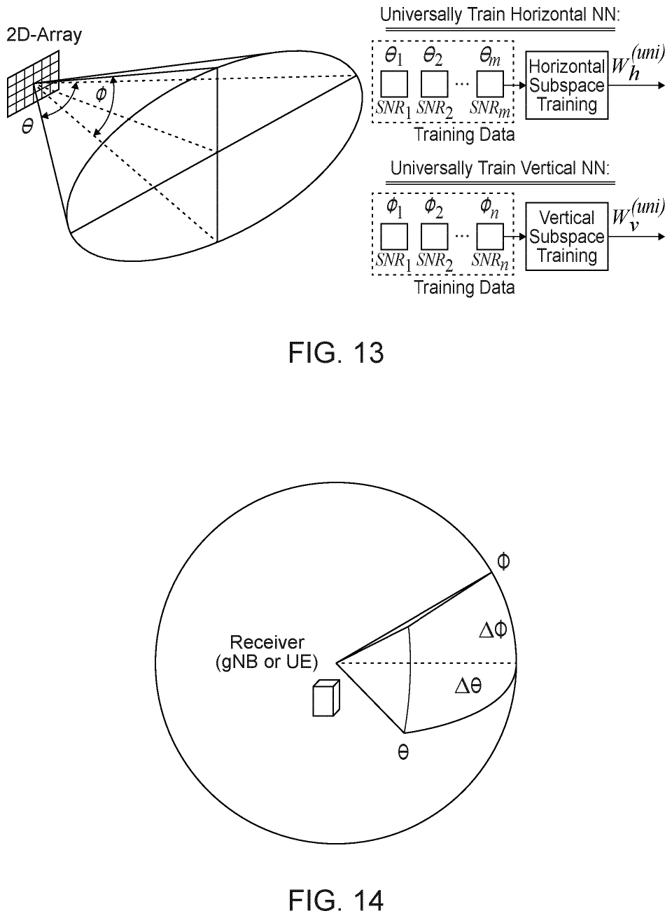

Referring next to FIGS. 13 and 14, in a modification to the method described previously with reference to FIGS. 1 to 12, each of the first and second, vertical and horizontal, neural network models is trained using training data corresponding to a range of spatial relationships between the base station x and user equipment such as handset x.

Referring firstly in particular to FIG. 13, the first, vertical, neural network mode is trained using labelled training data corresponding to a range of azimuthal angular positions, ϕ₁ to ϕₙ. Similarly, the second, horizontal, neural network model is trained using labelled training data corresponding to a range of elevational angular positions, θ₁ to θₙ. As a consequence of each model being trained using training data spanning a range of spatial positions, each model is suitable for estimating channel for any position in that range. Thus, in the example, the vertical neural network model is suitable for estimating channel in a communication with user equipment at any elevational position ϕ₁ to ϕₙ, and the horizontal neural network model is suitable for estimating channel in a communication with user equipment at any azimuthal position θ₁ to θₙ. The vertical and horizontal neural network models together are thus suitable for estimating channel of any communication in a direction spanned by the angular positions ϕ₁ to ϕₙ and θ₁ to θₙ.

This semi-universality of the neural network models has two key advantages compared to the neural network models described with reference to FIGS. 1 to 12. Firstly, because each model is useful for estimating channel across a range of spatial positions, the accuracy to which user equipment is required to identify its spatial position and retrieve correctly trained neural network models during the inference stage is reduced. In other words, because the models are useful for a range of spatial positions, it is necessary only that the user equipment is able to estimate its spatial position as being within that range. Furthermore, because the neural network models are each useful for a range of spatial positions, the total number of neural network models needed for estimating channel in a total area served by the base station is reduced. Consequently, comparatively fewer neural network models are required to be trained during the training stage 301, thereby potentially reducing training time, and fewer neural network models are required to be stored in memory for retrieval during the inference stage 302, thereby potentially reducing the total memory footprint of the channel estimation program.

Referring next to FIG. 14, during the inference stage 302, the receiver, in the example, hand set x, may retrieve trained neural network models by tuning the parameter space spanned by horizontal spatial range (θ,Δθ) and vertical spatial range (ϕ,Δϕ) and the range of SNR, to thereby retrieve trained vertical and horizontal neural network models. In the case of semi-universal models trained in accordance with the method described with reference to FIG. 13, the retrieved neural network models will be valid for user equipment whose parameters (θ,Δθ,ϕ,Δϕ,SNR) are located in the parameter space for which the semi-universal neural network models are trained.

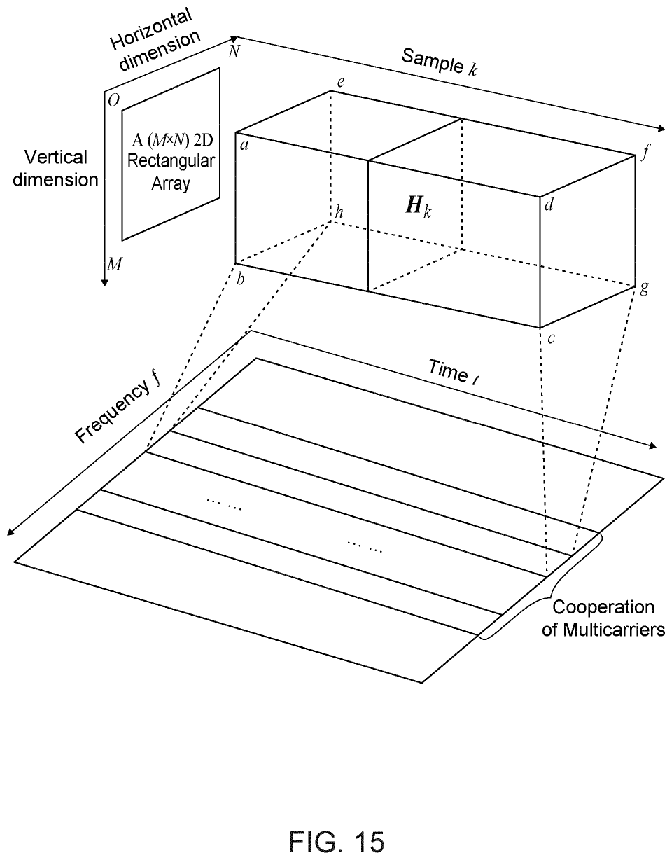

Referring finally to FIG. 15, the channel model for a received signal is presented as a four-dimensional structure, namely, in time, frequency, horizontal spatial domain, and vertical spatial domain.

In this modification to the treatment of a received signal, the high-dimensional data (observations and labels) structures may be reconstructed to lower-dimensional, two-dimensional, subspaces used as the inputs of a neural network model, which may be represented as sample covariance matrices of the received signal. After training in these lower-dimensional subspaces successively (with or without combining the channel estimates for the subspaces), the noise variance of the original high-dimensional data will be iteratively improved.

Although the present invention and its advantages have been described in detail, it should be understood that various changes, substitutions and alterations can be made herein without departing from the spirit and scope of the invention as defined by the appended claims. In the claims, the word “comprising” does not exclude other elements or steps, and the indefinite article “a” or “an” does not exclude a plurality.

1. A method of channel estimation for an antenna array, the method comprising:
receiving a signal transmitted by a first spatial dimension of the antenna array and by a second spatial dimension of the antenna array,
obtaining a first neural network model trained for channel estimation for the first spatial dimension of the antenna array, and a second neural network model trained for channel estimation for the second spatial dimension of the array using the received signal,
inputting a representation of the received signal for the first spatial dimension of the antenna array into the first neural network model and generating a channel estimate for the first spatial dimension of the array, and inputting a representation of the received signal for the second spatial dimension of the antenna array into a second neural network model and generating a channel estimates for the second spatial dimension of the antenna array, combining the channel estimates for the first spatial dimension of the antenna array and for the second spatial dimension of the antenna array to generate a channel estimate for the antenna array, and
deciding whether to employ a further neural network model for the channel estimation.

2. The method of claim 1, comprising:
deciding to employ a further neural network for the channel estimation,
obtaining a further neural network model trained for channel estimation using the channel estimate generated by the neural network model, and
inputting the channel estimate into the further neural network model to generate a further channel estimate for the received signal.

3. The method of claim 1, wherein deciding whether to employ a further neural network model for the channel estimation comprises determining a computational capacity for performing operations of a further neural network model.

4. The method of claim 1, wherein obtaining the neural network model comprises training a neural network model for channel estimation using labelled input data, storing parameters of the trained neural network model in memory, and retrieving the stored parameters from the memory.

5. The method of claim 2, wherein obtaining the further neural network model comprises training a further neural network model using a channel estimation of the neural network model and a label of the input data, storing parameters of the trained further neural network in memory, and retrieving the stored parameters from the memory.

6. The method of claim 1, wherein inputting a representation of the received signal into the neural network model comprises inputting a spatial or sample covariance matrix representation of the received signal.

7. The method of claim 1, wherein obtaining the neural network model comprises training a neural network model for channel estimation using labelled input data corresponding to a plurality of spatially different spatial positions, storing parameters of the trained neural network model in memory, and retrieving the stored parameters from the memory.

8. The method of claim 1, wherein combining the channel estimates for the first spatial dimension of the antenna array and for the second spatial dimension of the antenna array comprises computing an arithmetic mean or a geometric mean of the channel estimates.

9. The method of claim 1, wherein the first and second spatial dimensions are horizontal and vertical dimensions respectively of the two-dimensional antenna array.

10. The method of claim 1, wherein obtaining a first neural network model trained for channel estimation for the first spatial dimension of the antenna array, and a second neural network model trained for channel estimation for the second spatial dimension of the array, comprises training first and second neural network models respectively for channel estimation using labelled training data.

11. The method of claim 1, wherein obtaining a first neural network model trained for channel estimation for the first spatial dimension of the antenna array, and a second neural network model trained for channel estimation for the second spatial dimension of the array, comprises training first and second neural network models respectively for channel estimation using labelled training data corresponding to a plurality of spatially different spatial positions.

12. The method of claim 1, further comprising
receiving a signal transmitted by a third spatial dimension of the antenna array and by a fourth spatial dimension of the antenna array,
obtaining a third neural network model trained for channel estimation for the third spatial dimension of the antenna array, and a fourth neural network model trained for channel estimation for the fourth spatial dimension of the array,
inputting a representation of the received signal for the third spatial dimension of the antenna array into the third neural network model and generating a channel estimate for the third spatial dimension of the array, and inputting a representation of the received signal for the fourth spatial dimension of the antenna array into the fourth neural network model and generating a channel estimate for the fourth spatial dimension of the antenna array, and
combining the channel estimates for each of the first to the fourth spatial dimensions of the antenna array to generate a channel estimate for the antenna array.

13. The method of claim 12, wherein the third and fourth spatial dimensions are mutually different diagonal dimensions of the two-dimensional antenna array.

14. A non-transitory computer readable medium comprising a computer program comprising instructions, which, when executed with an apparatus, cause the apparatus to perform the method of claim 1.

15-16. (canceled)

17. The apparatus as in claim 20 where the apparatus comprises the antenna array.

18. The apparatus as in claim 17 where the apparatus comprises a base station for a wireless communication network, the base station comprising the antenna array, where the base station and the antenna array are configured for wirelessly communicating with remote user equipment.

19. The apparatus as in claim 18 where the apparatus comprises a wireless communication network, the network comprising the base station and the remote user equipment in wireless communication with the base station via the antenna array.

20. An apparatus comprising:
at least one processor; and
at least one non-transitory memory storing instructions that, when executed with the at least one processor, cause the apparatus to perform:
receiving a signal transmitted by a first spatial dimension of an antenna array and by a second spatial dimension of the antenna array,
obtaining a first neural network model trained for channel estimation for the first spatial dimension of the antenna array, and a second neural network model trained for channel estimation for the second spatial dimension of the array using the received signal,
inputting a representation of the received signal for the first spatial dimension of the antenna array into the first neural network model and generating a channel estimate for the first spatial dimension of the array, and inputting a representation of the received signal for the second spatial dimension of the antenna array into a second neural network model and generating a channel estimates for the second spatial dimension of the antenna array, combining the channel estimates for the first spatial dimension of the antenna array and for the second spatial dimension of the antenna array to generate a channel estimate for the antenna array, and
deciding whether to employ a further neural network model for the channel estimation.
